(19) United States
(12) Patent Application Publication
(10) Pub. No.: US 2026/0235198 A1
(43) Pub. Date: Aug. 13, 2026

(54) IMPROVED FILTERING PULLEY

(71) Applicant: MUVIQ S.R.L., Ivrea (IT)

(72) Inventors: Christopher R. BUDDINGTON, Livonia, MI (US); Gianluca CARICCIA, Ivrea (IT); Barry ALTMAN, Mount Clemens, MI (US); Michael WEISS, Ingersheim (DE); Andrea GUALA, Ivrea (IT)

(73) Assignee: MUVIQ S.R.L., Ivrea, TO (IT)

(21) Appl. No.: 19/154,133

(22) PCT Filed: Feb. 5, 2024
(86) PCT No.: PCT/IB2024/051038

§ 371 Date: Aug. 6, 2025

(30) Foreign Application Priority Data
Feb. 6, 2023 (IT) 102023000001902

(51) Int. Cl. F16H 55/36; F16F 15/121

(52) U.S. Cl. CPC F16H 55/36; F16F 15/121; F16H 2055/366

(57) ABSTRACT

Filtering pulley has a hub adapted to be fixed to a shaft rotating around an axis (A), a crown mounted coaxially and rotationally free on the hub, at least one elastic group arranged circumferentially with respect to hub and crown and interposed, each, between a pair of first elements fixedly carried by said hub and between a pair of second elements fixedly carried by the crown. The hub has a two part construction, a first element and a second element connected together by fixing means. The first element of the hub carries the pair of first elements and the second element of the hub is configured to be connected to the shaft.

### CROSS-REFERENCE TO RELATED APPLICATIONS

This Patent Application claims priority from Italian Patent Application No. 102023000001902 filed on Feb. 6, 2023, the entire disclosure of which is incorporated herein by reference.

### TECHNICAL FIELD OF THE INVENTION

The present invention relates to a filtering pulley, preferably a pulley for a crankshaft in an accessory drive of an internal combustion engine.

### STATE OF THE ART

As is known, the drive shaft in internal combustion engines is subjected to torsional vibrations due to the periodic stress caused by the combustion in the cylinders. Such vibrations are particularly intense at the start and at low speeds, as well as in the presence of particular constructional solutions such as, for example, the use of double clutch gearboxes or start-stop systems.

The torsional vibrations result in rotational irregularities of the drive pulley of the accessory drive which are transmitted to the accessories by means of the drive belt, which is thus subjected to periodic tension variations.

With the object “to filter” the torsional oscillations transmitted from the crankshaft to the belt, a filtering pulley is generally used as drive pulley, said filtering pulley being provided with a hub integral with the drive shaft, a crown cooperating with the belt and one or more elastic elements through which the torque is transmitted from the hub to the crown. The filtering pulley may be also provided with damper means. An example of such filtering pulley is illustrated in WO2022/243857 A1.

The known filtering pulleys are therefore heavy elements that may weight over 15 kg. This lead to many inconveniences.

First, their weight does not allow manual handling of the filtering pulley, therefore it is requested to use lifters and other machines for handling the filtering pulley. Clearly, this request is expensive and complicates the assembly of the filtering pulley.

Moreover, the assembly of the filtering pulley with the aforementioned lifters results more complicated due to the low visibility caused by the radial extension of the pulley that covers the hub portion that needs to be coupled to the crankshaft.

In view of the above there is need to provide a filtering pulley whose assembly is simplified and more economic with respect to the existing ones.

### SUBJECT AND SUMMARY OF THE INVENTION

The aforementioned object is achieved by a filtering pulley assembly according to what claimed in the appended claims.

### BRIEF DESCRIPTION OF THE DRAWINGS

In order to better understand the present invention, a preferred embodiment is described in the following, by way of non-limiting example and with reference to the accompanying drawings, wherein:

FIG. 1 is a sectional diametral view according to a first embodiment of the pulley of the invention;

FIG. 2 is an exploded view of pulley assembly of FIG. 1 along its longitudinal axis; and

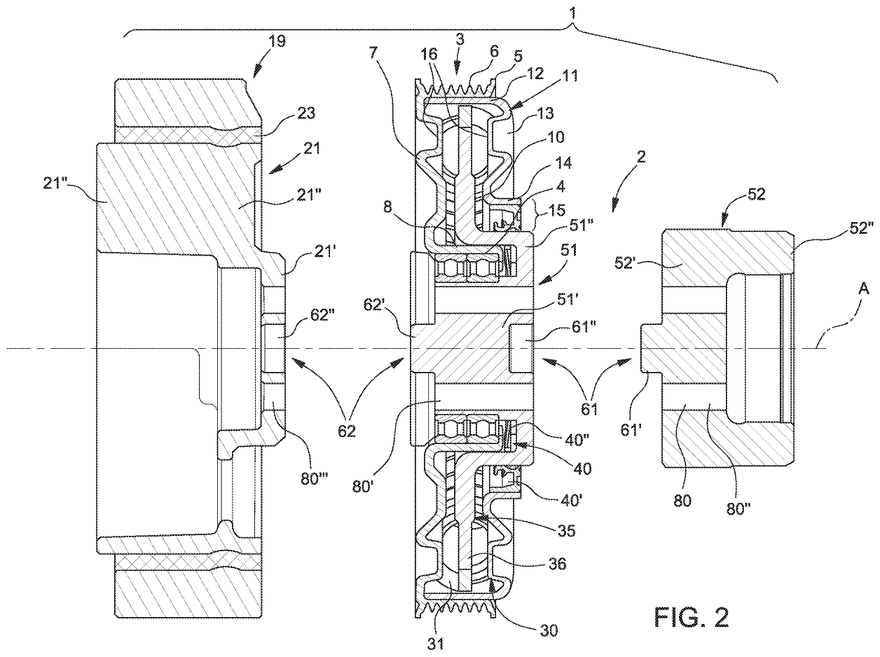

FIG. 3 is a sectional diametral view according to a first embodiment of the pulley of the invention; and

FIG. 4 is an exploded view of pulley assembly of FIG. 3 along its longitudinal axis.

### DETAILED DESCRIPTION OF PREFERRED EMBODIMENTS OF THE INVENTION

In the accompanying figures, a filtering pulley assembly 1 is represented comprising a hub 2 of axis A, adapted to be connected to a shaft (not represented), for example a crankshaft of an internal combustion engine, and an annular crown 3 externally coaxial to the hub 2 and supported in a rotationally free manner on the hub 2 by means supporting means 4.

The crown 3 comprises an annular portion 5 provided with a profile 6 adapted to cooperate with a poly-V belt (not represented). The crown 3 further comprises a radial wall 7, integral with the annular portion 5 and preferably of a single piece therewith, extending radially towards the hub 2 from the annular portion 5, and a substantially cylindrical internal wall 8 of axis A extending from a terminal portion of the radial wall 7 opposite to the annular portion 5.

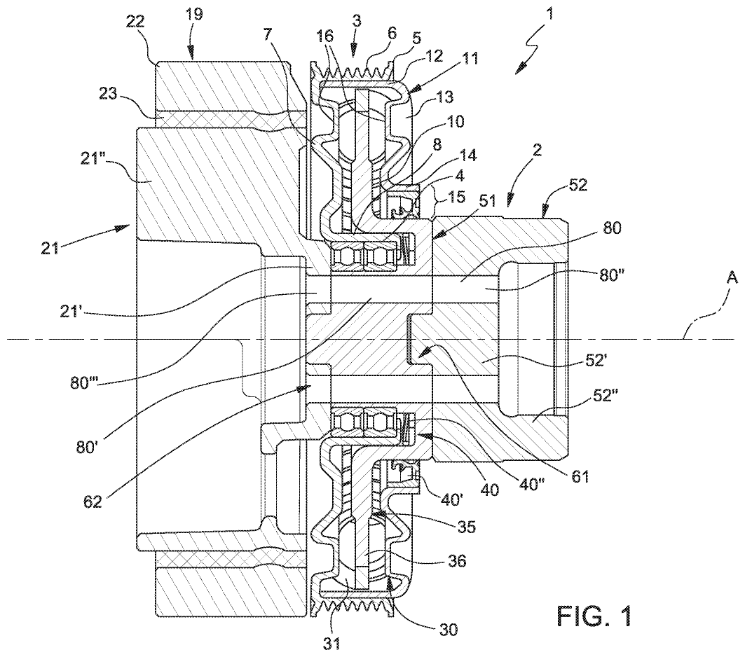

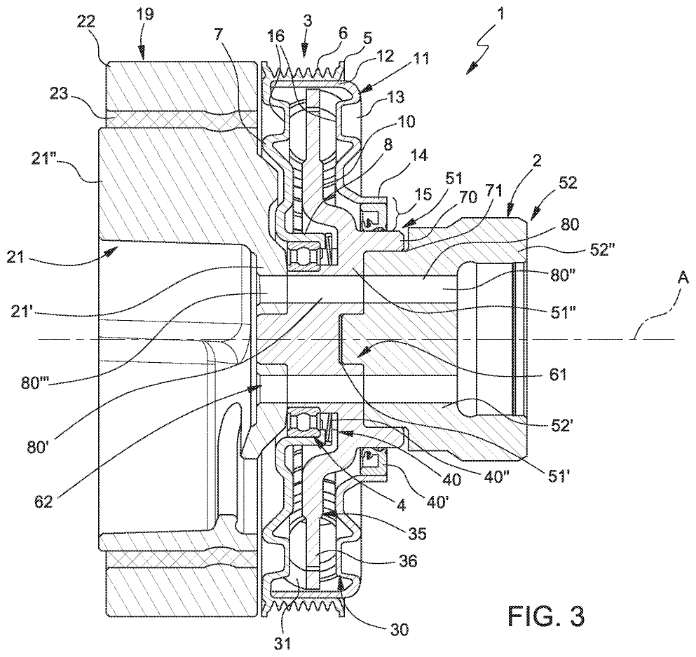

Preferably, internal wall 8 cooperates with supporting means 4 that in the disclosed embodiment are represented by at least one rolling bearing; in particular the embodiment of FIG. 1 comprises a pair of bearings while the embodiment of FIG. 3 comprises only one bearing.

The crown 3 carries, integral thereto, a closing element 11 configured to cooperate with the crown 3 to delimit a space 10. In particular the closing element 11 comprises an outer cylindrical wall 12 of axis A, a radial annular wall 13 extending radially from an axial terminal portion of the cylindrical wall 12 opposite to wall 7 and a terminal wall 14 extending axially of axis A from a terminal portion of the radial annular wall 13 opposite to the cylindrical wall 12.

The closing element 11 is driven into the crown 3 so as to form the aforementioned space 10 that is in particular an annular space radially comprised between the wall 12 and the wall 8 and axially delimited by the wall 7 and the wall 13.

In particular the wall 13 extends radially less than walls 13 therefore providing an annular clearance 15 between the wall 8 and the hub 2.

At least one between the crown 3 and the closing element 11 comprises two diametrically opposite projections 16 axially extending inside the space 10 starting from the faced wall 7 and 13. The projections 16 divide the space 10 into two portions preferably of equal dimensions.

The aforementioned projections 16 are carried fixed by the respective walls or, alternatively, made of a single piece with the same. In the disclosed embodiment, the projections 16 are realized as protuberances integrally realized in both walls 7 and 13.

The pulley assembly 1 can further be provided with a damper 19, such as a torsional vibration damper, comprising hub portion 21 fixedly carried by hub 2, a seismic ring 22 carried by the hub portion 21 and a deformable ring 23 operationally interposed between the hub portion 21 and the seismic ring 22; in particular the deformable ring 23 is made of elastomeric material.

In particular, the hub portion 21 comprises a coupling portion 21′ configured to be fixedly carried by the hub 2 and a disc portion 21″ extending from the coupling portion 21″ opposite to the hub 2.

As is illustrated, the pulley 1 further comprises at least one elastic group 30, for example two elastic groups 30 arched and arranged circumferentially free in the respective portions of the chamber 10 delimited by the projections 16.

Each of the elastic groups 30 comprises at least one spring, in the described embodiment a helical and arched spring 31 mounted between the aforementioned projections 16.

The pulley 1 further comprises an actuator 35 fixedly carried by the hub 2. The actuator 35 has two spokes 36 free to move circumferentially in the space 10 and adapted to interact with the elastic groups 30 by contact as described in the following.

The actuator 35 can be placed in contact with the elastic groups 30, possibly with a circumferential interference value so as to preload the elastic groups 30 inside the space 10 or, alternatively, it can be placed with an angular play with respect to the elastic groups 30, i.e. an angular clearance before entering into contact with these latter.

The pulley 1 can also further comprise dust protection means 40 configured to configured to isolate the space 10 from the outside.

In particular, the pulley 1 comprises first protection means 40′, preferably configured as a dust protection lip such as a labyrinthic seal, placed radially in annular clearance 15, in particular between closing element 11, namely the inner wall 14, and the hub 2. Accordingly, the first protection means 40′ isolates space 10 from the environment.

Preferably, the pulley 1 further comprises second protection means 40″, placed axially between hub 2 and crown 3, in particular between the inner wall 8 of crown 8 and spokes 36 carried fixedly by hub 2. Accordingly, the second protection means 40″ isolates space 10 from support means 4.

Advantageously, the second protection means 40″ comprises an elastic element configured to give an axial compression force along the axis A and a sealing element configured to be placed in contact with the wall 8.

According to the invention, the hub 2 comprises a plurality of elements 51, 52 connected together via respective shape coupling.

In particular, a first element 51 carries the actuator 35 and a second element 52 is configured to be fixed to the crankshaft of the engine and shape coupled to the first portion.

The second element 52 comprises a main element 52′ that is substantially cylindrical and a coupling element 52″ extending axially from the main element 52′ and configured to allow coupling with the crankshaft. In the disclosed embodiments the coupling element 52″ is substantially annular, however, it is clear that any shape can be provided according to the needed shape for coupling with the crankshaft.

The first element 51 comprises a main portion 51′ that is substantially cylindrical and a flange portion 51″ extending radially from a first extremity along axis A of the main portion 51′. The flange portion 51″ inner radially delimit the annular clearance 15 and therefore supports the first protection means 40′.

The flange portion 51″ furthermore carries the aforementioned spokes 36 of the actuator 35. In detail, the flange portion 51′ is L-shaped in order to pass through the annular clearance 15 and allows the support of spoked 36 in order to allow these latter to radially expands within space 10 in direction of wall 12 of closure element 11.

In further detail, the spokes 36 are realized monolithic with the hub 2 and in particular with the flange portion 51″ of the first element 51.

As said, the first and the second elements 51, 52 are mechanically coupled by a shape coupling 61. Preferably such shape coupling 61 comprises a protrusion 61′ carried in a fixed manner to one between the first and the second elements 51, 52 and a seat 61″ realized in the other between the first and the second elements 51, 52; such protrusion 61′ is configured to be housed within seat 61″. In particular, the protrusion 61′ is seated in seat 61″ with a pre-set interference.

Advantageously, the protrusion 61′ is realized as a cylindrical plug configured to be housed in a cylindrical seat 61″. In the disclosed embodiment, the protrusion 61′ is realized on the second element 52 and the seat 61″ is realized in the first element 51.

The protrusion 61′ and the seat 61″ are advantageously parallel and more preferably concentric to axis A.

Advantageously, the first element 51 is connected to the hub portion 21 of the damper 19 via a shape coupling 62. Preferably such shape coupling 62 comprises a protrusion 62′ carried in a fixed manner to one between the first element 51 and the hub portion 21 and a seat 62″ realized in the other between the first element 51 and the hub portion 21; such protrusion 62′ is configured to be housed within the seat 62″. In particular, the protrusion 62′ is seated in seat 62″ with a pre-set interference.

Advantageously, the protrusion 62′ is realized as a cylindrical plug configured to be housed in a cylindrical seat 62″. In the disclosed embodiment, the protrusion 62′ is realized on the first element 51 and the seat 62″ is realized in the hub portion 21.

The protrusion 62′ and the seat 62″ are advantageously parallel and more preferably concentric to axis A, therefore being concentric to the protrusion and seat 61′, 61′ of the shape coupling 61 between first and second elements 51, 52 of hub 2. In particular, such shape couplings 61, 62 have the same shape and dimensions.

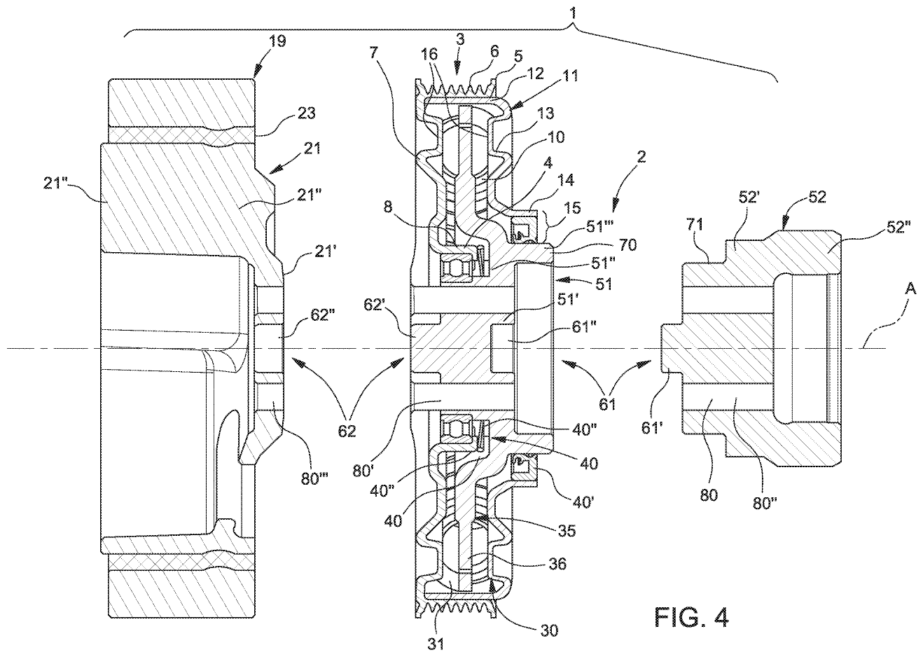

In the embodiment of FIGS. 3 and 4, the first element 51 of the hub further comprises an axial flange 70 extending parallel to axis A from the flange portion 51″ towards the second element 52. In particular, the axial flange 70 extends along axis A over the main portion 51′. Accordingly, axial flange 70 is substantially an annular flange about axis A.

The axial flange 70 is configured to cooperate at contact with a shoulder 71 realized in the main portion 52 of the second element 52, in particular on a side opposite to coupling portion 52″ thereof.

The shoulder 71 is therefore annular and dimensioned to seat flange 70, preferably with a pre-set radial interference.

Clearly, shoulder 71 and flange 70 may be realized oppositely to the described configuration, i.e. the axial flange 70 extending from the second element 52 and the seat realized in the first element 51.

In both embodiments, the elements 51, 52 and the hub portion 21 of the damper 19 are connected together via fixing means (not shown) such as threaded connection, e. g. bolts.

Accordingly, pulley 1 comprises axial openings 80 configured to allow the insertion and coupling of such fixing means. Preferably such axial openings 80 are at least four openings placed circumferentially spaced about axis A, more preferably equally spaced one with respect to the other.

In particular, the first element 51 comprises a first section 80′ of such axial openings 80, the second element 52 comprises a second section 80″ of such axial openings 80 and the hub portions 21 comprises a third section 80′″ of such axial openings 80.

The operation of the pulley 1 according to the above two described embodiments follows.

During the standard operation of the pulley 1, in a first operational step, called driving mode and constituting the normal operation of the pulley 1, when the drive shaft pulls the accessories, the speed of the hub 2 tends to exceed the speed of the crown 3. For this reason, the spokes 36 of the actuator 35 transmit the torque to the projections 16 with the interposition of the respective elastic groups 30.

What described above occurs, symmetrically, in the overrunning condition, i.e. when the speed of the crown 3 tends to exceed the speed of the hub 2.

The mounting operation of the pulley 1 foresees the fixation of the second element 52 on the crankshaft, then the positioning of the first element 51 on the second element 52 and, if needed, the further positioning of the damper 19 on the first element 51. The shape couplings 61, 62 are then loaded thereby rigidly fixing together all the hub elements via the fixing means inserted and coupled within the openings 80.

In the embodiments of FIGS. 3 and 4, the axial portion 70 cooperates with the shoulder 71 thereby providing a more robust provisional coupling between the first and second elements 51, 52 in order to provide a more safe condition for the user to insert fixing means in openings 80.

The advantages of a pulley 1 according to the invention are thus evident.

Thanks to the subdivision of the hub into a plurality of portions, the overall weight of the pulley is reduced thereby allowing the user to manually handle the latter.

In this way, it is avoided the use of handling machines and therefore their related costs and imprecisions are avoided.

Moreover, the possibility of fixing one hub portion directly to the crankshaft and after fixing the other portion to the fixed one allows an easy connection to the crankshaft due to improved visibility of the user.

Furthermore, the same advantages may be brought in case of presence of damper that can be connected to the hub in the same way.

In case of presence of axial projection and shoulder in addition to the shape coupling between the hub portions, the safety of the mounting operation is increased since the two coupled elements are more safely secured so as to allow the user to complete the pulley assembly.

In view of the above, the overall assembly of the pulley is simplified, more safe and economic.

Finally, it is clear that modifications or variations can be made to the described pulley which do not depart from the scope of protection defined by the claims.

First of all, the pulley could be used not exclusively on the crankshaft of an internal combustion engine but for one of the accessories of the same.

With reference to the elastic group 30, they could be realized in many different manners without anyway modifying their function. For example, they could comprise springs of different nature or several springs, in series or in parallel. Still, the elastic groups could be four and likewise the spokes of the actuator.

The dynamic damper could be absent and the actuator could be carried differently by the hub. Likewise, the roller bearings can be replaced by a bush.

Still, the sealing element 42 or the spring 43 could be replaced by devices having the same function.

1. Filtering pulley comprising a hub adapted to be fixed to a shaft rotating around an axis (A), a crown mounted coaxially and rotationally free on said hub, at least one elastic group arranged circumferentially with respect to said hub and said crown and interposed, each, between a pair of first elements fixedly carried by said hub and between a pair of second elements fixedly carried by said crown characterized in that said hub comprises a first element and a second element realized as separate elements connected together by fixing means, said first element carrying said pair of first elements and said second element being configured to be connected to said shaft.

2. Pulley according to claim 1, wherein said first element and said second element are connected by a shape coupling.

3. Pulley according to claim 2, wherein shape coupling comprises a protrusion carried in a fixed manner to one between said first and second elements and a seat realized in the other between said first and second elements.

4. Pulley according to claim 3, wherein said protrusion and said seat are cylindrical.

5. Pulley according to claim 3, wherein said protrusion and said seat are coaxial to said axis (A).

6. Pulley according to claim 2, wherein at least one between said first and second elements defines an axial flange configured to cooperate at contact with a shoulder realized in the other between said first and second elements.

7. Pulley according to claim 6, wherein said axial flange is located radially outer to said axis (A) with respect to said shape coupling.

8. Pulley according to claim 1 further comprising a dynamic damper carried by said hub.

9. Pulley according to claim 8, wherein said dynamic damper comprises a hub portion carried by said first element via a shape coupling.

10. Pulley according to claim 9, wherein the shape coupling comprises a protrusion carried in a fixed manner to one of said first element and said hub portion and a seat realized in the other of said first element and said hub portion.

11. Pulley according to claim 10, wherein the first element and the second element of the hub are connected by a shape coupling, wherein the shape coupling comprises a protrusion carried in a fixed manner to one of the first and second elements of the hub and a seat realized in the other of the first and second elements of the hub, wherein said shape couplings are coaxial to said axis (A).

12. Pulley according to claim 10, wherein the first element and the second element of the hub are connected by a shape coupling, wherein the shape coupling comprises a protrusion carried in a fixed manner to one of the first and second elements of the hub and a seat realized in the other of the first and second elements of the hub, wherein said shape couplings are equal.

13. Pulley according to claim 1, wherein said pair of first elements is realized monolithic with said first element.

14. Pulley according to claim 1, wherein said pair of second elements are projections integral with an element of said crown.

15. Pulley according to claim 1, wherein said at least one elastic group is circumferentially sliding inside a space formed between the pair of first elements and/or the pair of second elements.
